(19) United States
(12) Patent Application Publication
(10) Pub. No.: US 2017/0123045 A1
(43) Pub. Date: May 4, 2017

(54) MOBILE APPARATUS FOR MEASURING RELATIVE LOCATION BASED ON UWB AND METHOD THEREOF

(71) Applicant: INDUSTRIAL BANK OF KOREA, Seoul (KR)

(72) Inventors: Pilsoon SHIN, Busan (KR); Jongman KWON, Gwangju-si (KR)

(21) Appl. No.: 14/927,060

(22) Filed: Oct. 29, 2015

(51) Int. Cl. G01S 5/02

(52) U.S. Cl. CPC G01S 5/0289

(57) ABSTRACT

The present invention provides a mobile device for measuring a relative location based on UWB and a method of measuring a relative location using the same. A mobile device for measuring a relative location according to an embodiment of the present invention includes a plurality of UWB module units configured to transmit and receive a signal to and from a UWB tag; a micro controller unit (MCU) unit configured to calculate distance information of the UWB tag from a signal transmission and reception relation between the plurality of UWB module units and the UWB tag; an access point linking unit configured to transmit the distance information calculated in the MCU unit to an adjacent access point; and a driving unit provided at one side of the location measuring device and enabling the location measuring device to be movable.

### BACKGROUND

1. Field of the Invention

The present invention relates to a mobile apparatus for measuring a relative location based on UWB and a method of measuring a relative location using the same.

2. Discussion of Related Art

For commercial location identifying or location measuring systems, there are methods using a Global Positioning System (GPS), an Inertial Navigation System (INS), Long Range Aid to Navigation (LORAN), Radio Frequency Identification/Ubiquitous Sensor Network (RFID/USN), a wireless communication network or the like.

Among these, “wireless location measuring technology,” which is a method using the wireless communication network, utilizes CDMA, OFDM, WLAN, infrared rays, ultrasonic waves, Bluetooth, RFID, UWB or the like in real time. Cell-ID, ToA, TDoA, AoA, or fingerprint techniques are used in order to accurately measure a location of a terminal, and technology development of wireless location measuring technology has been actively progressing in addition to technology concentration of the Internet of Things (IoT). In particular, a location measuring method based on UWB is short-distance high-speed data transmission technology that is based on an ultra-wideband of IEEE 802.15.3a and is able to transmit multimedia data at low power through a wide bandwidth of 500 MHz or more. Comparing technologies of the related art based on WiFi or Bluetooth signals, there are advantages in that it is possible to accurately measure a distance at a high speed, and perform implementation at a low cost with reduced power consumption.

General location measuring schemes have a limitation that, since a location of a tag, which is a measurement target, located in a limited space or area is measured while a location collecting device is built in a space or area in which location measuring is performed, location measurement is possible in only a limited area. When a plurality of prior patent documents of a location measuring method and system based on UWB are reviewed, although the documents do not limit location measurement to a limited space or area, it is possible to recognize the above limitation according to components of individual technical documents.

Recently, in unmanned aircraft called a drone or mobile robots, in order for a device in which a data communication function such as the Internet of Things (IoT) is added to a mechanical power device of the related art to provide a desired service to a specific target object, demand for location identifying technology based on various sensors increases.

Therefore, the present inventors have recognized limitations of location measuring schemes of the related art and the advent of technical demand to propose the present invention in order to address the above-described problems.

### SUMMARY OF THE INVENTION

The present invention provides a device configured to measure a location of a UWB tag in a movable manner.

The present invention also provides a method of measuring a location of a UWB tag using a mobile device for measuring a relative location.

As a first embodiment according to the present invention, a mobile device for measuring a relative location based on UWB is disclosed. The mobile device for measuring a relative location includes a plurality of UWB module units configured to transmit and receive a signal to and from a UWB tag; a micro controller unit (MCU) unit configured to calculate distance information of the UWB tag from a signal transmission and reception relation between the plurality of UWB module units and the UWB tag; an access point linking unit configured to transmit the distance information calculated in the MCU unit to an adjacent access point; and a driving unit provided at one side of the location measuring device and enabling the location measuring device to be movable, and may further include a driving control unit connected to the driving unit and configured to control a movement direction and a rotation direction of the driving unit.

As an additional aspect, in the mobile device for measuring a relative location, when the plurality of UWB module units receive a first impulse signal from the UWB tag, calculation of distance information of the UWB tag may start. In this case, the plurality of UWB module units may transmit a response signal in response to the first impulse signal to the UWB tag, and receive a second impulse signal in response to the response signal.

As still another aspect, a signal transmission and reception relation that is a factor for the MCU unit to calculate distance information of the UWB tag may be a relation between the response signal and the second impulse signal.

Meanwhile, the MCU unit may calculate distance information of the UWB tag according to any one among received signal strength (RSS), time of arrival (ToA) of a signal, time difference of arrival (TDoA) of a signal, two-way ranging (TWR) and angle of arrival (AoA) of a signal.

As a second embodiment according to the present invention, a method of measuring a relative location in a movable manner based on UWB is disclosed. The method of measuring a relative location includes receiving a first impulse signal from a UWB tag; transmitting a response signal in response to the first impulse signal; receiving a second impulse signal from the UWB tag in response to the response signal; and measuring a distance from the UWB tag based on a relation between the response signal and the second impulse signal.

Also, the method of measuring a relative location according to the second embodiment may further include transmitting the measured distance to an access point; performing, by the access point, conversion into location additional information based on the measured distance; and transmitting the location additional information and the measured distance to a management server or an administrator terminal from the access point via a data communication network.

In the embodiment according to the present invention, a data communication network through which distance information and location additional information are transmitted and received from the access point to the management server or the administrator terminal may be one among a 3G mobile communication network, an LTE communication network, and a WiFi communication network.

As a third embodiment according to the present invention, there is provided a computer readable storage medium storing a computer program executing a method of measuring a relative location in a movable manner based on UWB. The computer program includes an instruction for receiving a first impulse signal from a UWB tag; an instruction for transmitting a response signal in response to the first impulse signal; an instruction for receiving a second impulse signal from the UWB tag in response to the response signal; and an instruction for measuring a distance from the UWB tag based on a relation between the response signal and the second impulse signal.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a diagram illustrating a functional configuration of a mobile system for measuring a relative location according to a first embodiment of the present invention;

FIG. 2 is a diagram illustrating a functional configuration of a mobile device for measuring a relative location according to a second embodiment of the present invention;

FIG. 3 is a diagram illustrating a functional configuration of a first implementation example of the mobile device for measuring a relative location illustrated in FIG. 2.

FIG. 4 is a second implementation example of the mobile device for measuring a relative location;

FIG. 5 is a signal sequence diagram illustrating a method of measuring a relative location in a movable manner according to a third embodiment of the present invention;

FIG. 6A illustrates a location measuring environment of a mobile device for measuring a relative location according to an embodiment of the present invention; and

FIG. 6B shows measurement results obtained by a mobile device for measuring a relative location according to an embodiment of the present invention.

### DETAILED DESCRIPTION OF EXEMPLARY EMBODIMENTS

Hereinafter, various embodiments of a mobile device for measuring a relative location based on UWB and a method thereof according to the present invention will be described with reference to the accompanying drawings.

It will be understood that the terms “comprise,” and “include,” when used herein, specify the presence of stated components, features, and operations, but do not preclude the presence of one or more other components, features, operations and equivalents thereof.

Also, the singular forms “a” and “an” are intended to include the plural forms as well, unless the context clearly indicates otherwise. That is, components stated as the term “include” herein refer to the presence or addition of one or more other components.

The term “access point” herein refers to a fixed station that is used to communicate with access terminals and may be called a node, an eNodeB, an HeNB or other terms. It will be understood that the access point refers to various devices having a function for communicating with terminals regardless of the terms “random access point,” “relay access point,” and “router access point” referred to in the market.

As a method of estimating a location using a property associated with a wireless frequency such as a wireless LAN (WLAN), measurement principles such as a time of arrival (TOA), a time difference of arrival (TDOA), a received signal strength indicator (RSSI), and an angle of arrival (AOA) which are generally used for location measurement based on a wireless mobile communication network may be applied. In general, a distance measuring method using attenuation of a wireless signal, a triangulation-based location measuring method, and a fingerprinting method using a pre-built propagation map are exemplified. Among position measurement methods based on such a wireless mobile communication network, UWB is known as a method that is designed to transmit a great amount of data with low power in a short distance and is able to more accurately perform position measurement than other communication methods according to frequency designation.

In addition, technical terms used throughout this specification are selected from among general technical terms that are currently and widely used. In certain cases, some terms may be arbitrarily selected by the applicants. In such cases, meanings thereof should be interpreted in consideration of a description of embodiments and meanings as used in context, rather than simply the terms themselves.

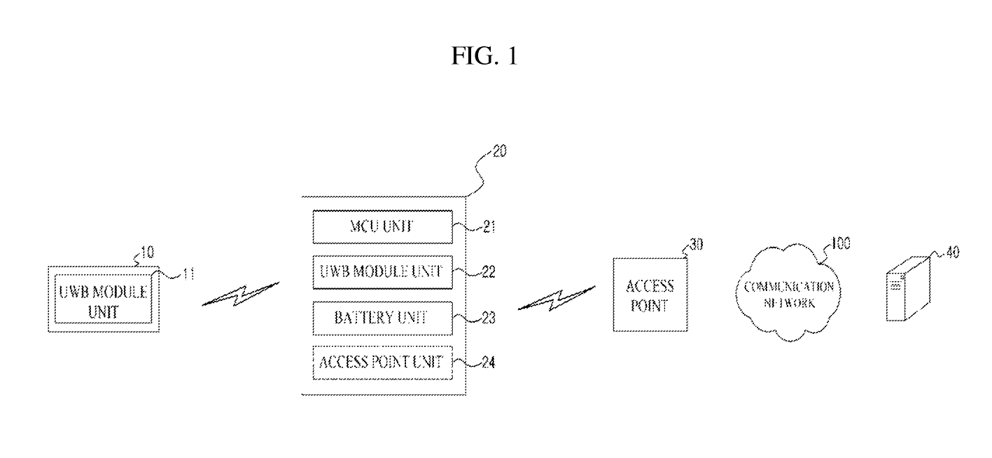

FIG. 1 is a diagram illustrating a functional configuration of a mobile system for measuring a relative location according to a first embodiment of the present invention. According to this diagram, the system includes a UWB tag 10, a mobile device for measuring a relative location 20, an access point 30, and a management server 40. Also, the access point 30 and the management server 40 can perform data communication via a communication network 100. Here, the communication network 100 may be one among a 3G mobile communication network, an LTE communication network, and a WiFi communication network, but the present invention is not limited to the proposed communication network types.

The UWB tag 10 includes a UWB module unit 11 configured to transmit and receive a UWB signal to and from the mobile device for measuring a relative location 20. The mobile device for measuring a relative location 20 includes a micro controller unit (MCU) 21, a UWB module unit 22, and a battery unit 23, and may selectively further include an access point unit 24.

The MCU unit 21 is a module that has a processor, a memory and a programmable input and output like a general microcontroller, is operated at a low clock rate, includes an analog-digital converter (ADC) and a digital analog converter (DAC), and is operated at low power of several mW to several μW. Since most MCUs can implement a computing function and an interrupt function and power of only several nW is consumed in an idle state or a pause state, these are controllers optimized for the mobile device for measuring a relative location 20 that should be operated for a long time with a low capacity battery.

The MCU unit 21 may measure a location of the UWB tag 10 according to a relation of signals measured by the UWB module unit 22. Distance information of the UWB tag 10 may be calculated by any one among received signal strength (RSS), time of arrival (ToA) of a signal, time difference of arrival (TDoA) of a signal, two-way ranging (TWR) and angle of arrival (AoA) of a signal according to setting methods of the MCU unit 21.

Meanwhile, when a plurality of UWB module units 22 included in the mobile device for measuring a relative location 20 receive a first impulse signal from the UWB tag 10, calculation of distance information of the UWB tag may start.

The battery unit 23 supplies driving power necessary for driving the mobile device for measuring a relative location 20, and may use a primary battery such as a lithium battery or a secondary battery such as a nickel-cadmium (NiCd) battery, a nickel-metal hydride (NiMH) battery, a lithium ion secondary battery, and a lithium ion polymer secondary battery, but the present invention is not limited thereto.

The access point unit 24 has a function of linking with the access point 30 configured to transmit data and information that are requested from the management server 40 via the communication network 100.

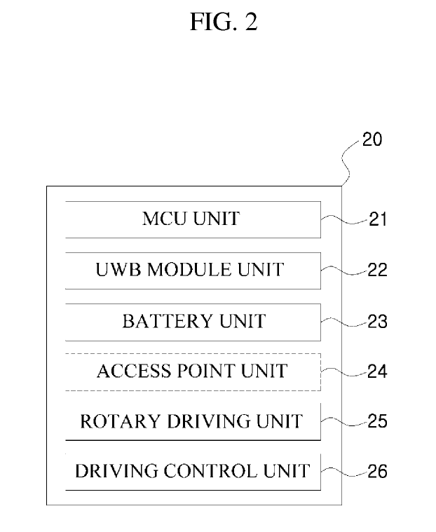

FIG. 2 is a diagram illustrating a functional configuration of a mobile device for measuring a relative location according to a second embodiment of the present invention. In addition to the MCU unit 21, the UWB module unit 22, the battery unit 23, and the access point unit 24 described in FIG. 1, a rotary driving unit 25 and a driving control unit 26 will be further described.

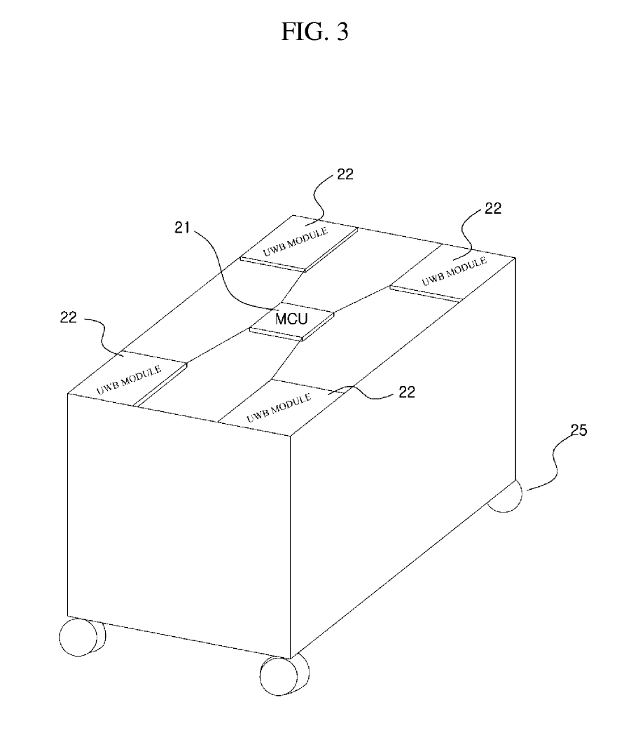

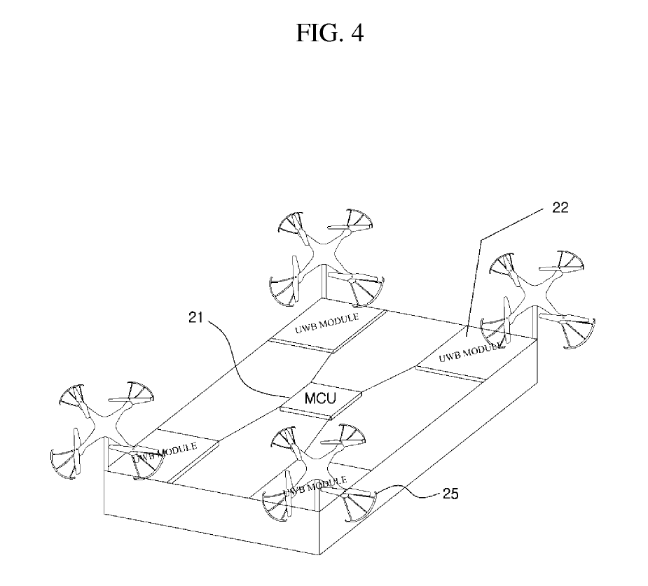

The rotary driving unit 25 refers to a functional configuration that is provided at one side of the mobile device for measuring a relative location 20 and enables the location measuring device 20 to be movable. As illustrated in FIG. 3, the rotary driving unit 25 may be implemented as a movable wheel type that is provided on a lower side and is movable in any direction in contact with a floor with which the location measuring device 20 comes in contact. In addition, as illustrated in FIG. 4, the rotary driving unit 25 may be implemented as a type of a driving motor linked with a propeller such as a form similar to a drone.

The driving control unit 26 performs control such that the rotary driving unit 25 can move in any specific direction or rotate in a specific orientation, and provides a resulting driving signal, power and/or voltage. For example, as illustrated in FIG. 3, according to specifications required for each case in which the rotary driving unit 25 is implemented as a movable wheel type or a type of a driving motor linked with a propeller, the driving control unit 26 may be provided in the mobile device for measuring a relative location 20 according to the present invention.

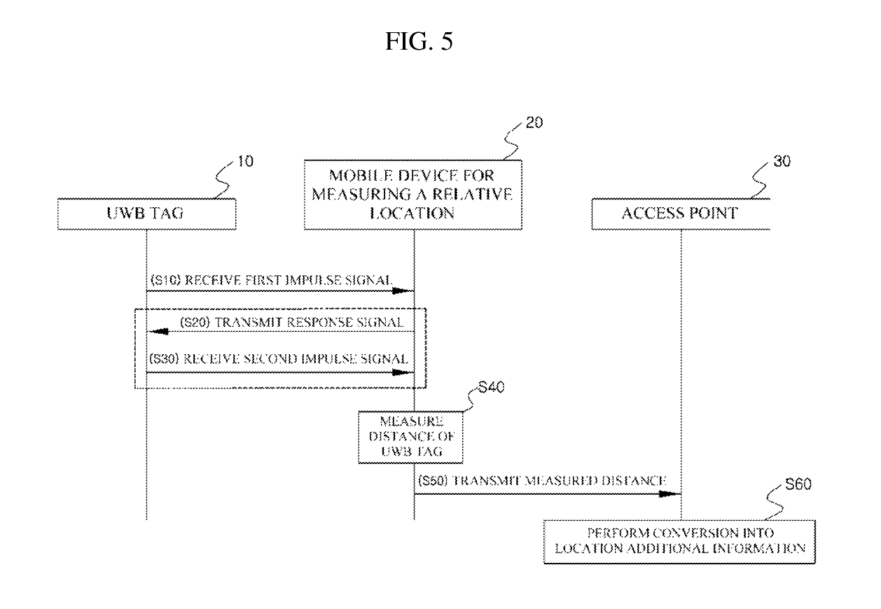

FIG. 5 is a signal sequence diagram illustrating a method of measuring a relative location in a movable manner according to a third embodiment of the present invention.

First, when the UWB tag 10 transmits a first impulse signal to a mobile device for measuring a relative location 20 and the mobile device 20 receives the first impulse signal (operation S10), measurement of a relative location of the mobile reception device with respect to the UWB tag 10 starts. The first impulse signal may be transmitted at pre-scheduled periods (for example, 100 ms or 50 ms). Accordingly, the mobile device 20 recognizes that the UWB tag 10 is closer thereto or is detected, and thus a location measurement aspect starts. In other words, the first impulse signal may be understood as a location measuring start signal.

Next, the mobile device 20 transmits a response signal in response to the first impulse signal (operation S20), and the UWB tag 10 transmits a second impulse signal in response to the response signal (operation S30).

The mobile device 20 may calculate a round trip time according to the response signal and the second impulse signal, and measure a distance between the UWB tag 10 and the mobile device 20 (operation S40). When the distance is measured, any technique among received signal strength (RSS), time of arrival (ToA) of a signal, time difference of arrival (TDoA) of a signal, TWR and angle of arrival (AoA) of a signal may be used.

Next, the mobile device 20 transmits information of the measured distance between the mobile device 20 and the UWB tag 10 to the access point 30 (operation S50). The access point 30 may perform conversion into location additional information based on the measured distance (operation S60). Here, the location additional information may refer to aspects in which location information of the UWB tag converted from distance information between the mobile device 20 and the UWB tag 10 is described in different expression forms.

Such location additional information and the measured distance information may be transmitted from the access point to the management server or an administrator terminal (not illustrated in FIG. 5).

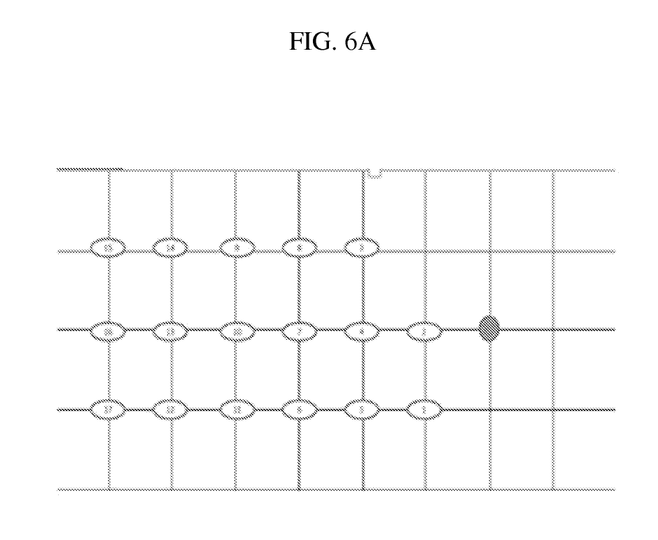

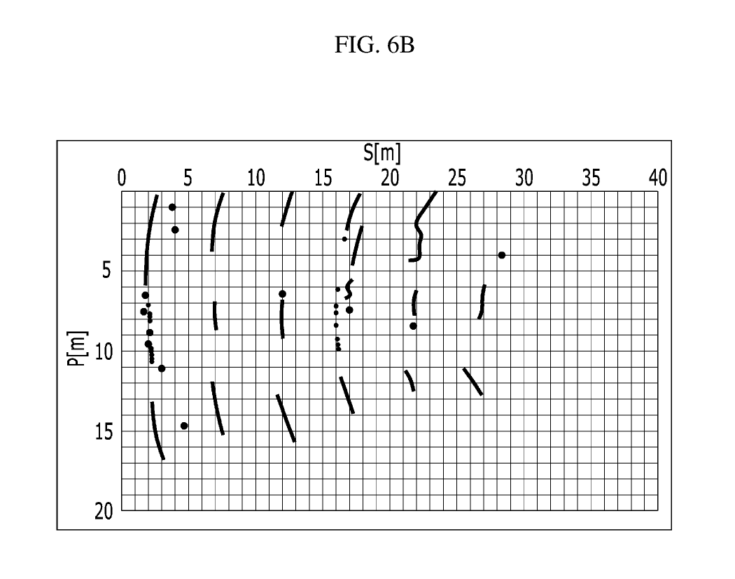

FIG. 6A illustrates a location measuring environment of a mobile device for measuring a relative location according to an embodiment of the present invention. FIG. 6B shows measurement results obtained by a mobile device for measuring a relative location according to an embodiment of the present invention. For example, it can be understood that the mobile device for measuring a relative location moves or the UWB tag moves according to a numbered sequence in FIG. 6A, and resulting location measuring outcomes may be illustrated as in FIG. 6B.

In various embodiments described herein, a location measuring method using the mobile device for measuring a relative location may be performed in the form of a computer program for implementing the same. In this case, the computer program may be stored in the form of a computer readable storage medium. The program may include an instruction for receiving a first impulse signal from a UWB tag; an instruction for transmitting a response signal in response to the first impulse signal; an instruction for receiving a second impulse signal from the UWB tag in response to the response signal; and an instruction for measuring a distance from the UWB tag based on a relation between the response signal and the second impulse signal.

According to the present invention, when location measurement is performed using a UWB signal in the related art, space constraints are minimized or eliminated. Therefore, it is possible to measure a location in linkage with various mobile devices.

Also, according to the method and device for measuring a relative location in a movable manner of the present invention, when specific services are provided for customers using unmanned aircrafts such as drones or mobile devices, applying location measurement using the UWB signal can be applied and thus it is possible to stably provide reliable services.

Further, when the method and device for measuring a relative location in a movable manner according to the present invention are linked with safety facilities, it is possible to provide an environment in which location measurement information can be used together with radar measuring devices of the related art.

It can be understood by those skilled in the art that effects of the present invention are not limited to the above descriptions but broader effects can be obtained.

Exemplary modules, logic blocks, units, operations or combinations thereof of embodiments described herein may be implemented by electronic hardware (a digital design designed by coding or the like), software (various types of applications including program instructions) or a combination thereof. An implementation type of hardware and/or software may be changed according to design constraints of user terminals.

In some embodiments, at least one configuration described herein may be stored in a memory as a computer program instruction. Such a computer program instruction may execute the method described herein with respect to a digital signal processor. Connection examples of components specified with reference to the accompanying drawings herein are only examples. It is needless to say that at least some of these may be omitted, or additional components may be added thereto.

The scope of the present invention described above is not limited by the above-described embodiments and accompanying drawings, but by the appended claims. It can be easily understood by those skilled in the art that a configuration of the present invention can be variously changed and modified without departing from the scope of the present invention.

### REFERENCE NUMERALS

10: UWB tag
20: mobile reception device
21: MCU unit
22: UWB module unit
23: battery unit
25: driving unit
30: access point
100: communication network
40: management server

What is claimed is:

1. A mobile device for measuring a relative location based on UWB, comprising
a plurality of UWB module units configured to transmit and receive a signal to and from a UWB tag;
a micro controller unit (MCU) unit configured to calculate distance information of the UWB tag from a signal transmission and reception relation between the plurality of UWB module units and the UWB tag;
an access point linking unit configured to transmit the distance information calculated in the MCU unit to an adjacent access point; and
a driving unit provided at one side of the location measuring device and enabling the location measuring device to be movable.

2. The mobile device for measuring a relative location based on UWB according to claim 1, further comprising
a driving control unit connected to the driving unit and configured to control a movement direction and a rotation direction of the driving unit.

3. The mobile device for measuring a relative location based on UWB according to claim 2,
wherein, when the plurality of UWB module units receive a first impulse signal from the UWB tag, calculation of distance information of the UWB tag starts.

4. The mobile device for measuring a relative location based on UWB according to claim 3,
wherein the plurality of UWB module units transmit a response signal in response to the first impulse signal to the UWB tag, and receive a second impulse signal in response to the response signal, and
the signal transmission and reception relation for calculating distance information in the MCU unit is a relation between the response signal and the second impulse signal.

5. The mobile device for measuring a relative location based on UWB according to claim 4,
wherein the MCU unit calculates distance information of the UWB tag according to any one among received signal strength (RSS), time of arrival (ToA) of a signal, time difference of arrival (TDoA) of a signal, two-way ranging (TWR) and angle of arrival (AoA) of a signal.

6. A method of measuring a relative location in a movable manner based on UWB, comprising:
receiving a first impulse signal from a UWB tag;
transmitting a response signal in response to the first impulse signal;
receiving a second impulse signal from the UWB tag in response to the response signal; and
measuring a distance from the UWB tag based on a relation between the response signal and the second impulse signal.

7. The method of measuring a relative location in a movable manner based on UWB according to claim 6, further comprising
transmitting the measured distance to an access point;
performing, by the access point, conversion into location additional information based on the measured distance; and
transmitting the location additional information and the measured distance to a management server or an administrator terminal from the access point via a data communication network.

8. The method of measuring a relative location in a movable manner based on UWB according to claim 7,
wherein the data communication network is one among a 3G mobile communication network, an LTE communication network, and a WiFi communication network.

9. A computer readable storage medium storing a computer program executing the method according to claim 6.

10. A computer readable storage medium storing a computer program executing the method according to claim 7.

11. A computer readable storage medium storing a computer program executing the method according to claim 8.
